(19) United States
(12) Patent Application Publication
(10) Pub. No.: US 2020/0331296 A1
(43) Pub. Date: Oct. 22, 2020

(54) PNEUMATIC TIRE AND METHOD FOR MANUFACTURING RUBBER COMPOSITION FOR TIRE USED FOR SAME

(71) Applicant: THE YOKOHAMA RUBBER CO., LTD., MINATO-KU, TOKYO (JP)

(72) Inventors: Hiroki SUGIMOTO, HIRATSUKA-SHI, KANAGAWA (JP); Keisuke MURASE, HIRATSUKA-SHI, KANAGAWA (JP)

(21) Appl. No.: 16/765,721

(22) PCT Filed: Nov. 28, 2018
(86) PCT No.: PCT/JP2018/043710

§ 371 Date: May 20, 2020

(30) Foreign Application Priority Data
Nov. 28, 2017 (JP) 2017-227932
Nov. 29, 2017 (JP) 2017-228789

(51) Int. Cl. B60C 1/00; C08L 7/00; C08J 3/20; B60C 11/00

(52) U.S. Cl. CPC B60C 1/0016; C08L 7/00; C08L 2207/322; B60C 11/005; C08L 2205/03; C08J 3/203

(57) ABSTRACT

A pneumatic tire includes a cap tread portion, an undertread portion, and a belt cover layer from outside to inside in the tire radial direction, a rubber composition for an undertread forming the undertread portion includes from 40 to 80 parts by mass of silica blended in 100 parts by mass of diene rubber containing 70 mass % or greater of natural rubber and/or isoprene rubber, and includes a silane coupling agent blended by an amount from 2 to 15 mass % with respect to the silica, a ratio (S_{UT}/M_{UT}) of tensile strength at break (S_{UT}) to 300% deformation tensile stress (M_{UT}) of the rubber composition for an undertread is 1.80 or greater, and an absolute value |M_{UT}-M_{BC}| of difference between the 300% deformation tensile stress (M_{UT}) and 300% deformation tensile stress (M_{BC}) of a rubber composition for a belt cover forming the belt cover layer is 3.0 MPa or less.

### TECHNICAL FIELD

The present invention relates to a pneumatic tire that provides excellent steering stability at high speeds, excellent tire durability, and excellent fuel economy performance, and a method for manufacturing a rubber composition for a tire used for the same.

### BACKGROUND ART

In Europe and the United States where a road network suitable for high-speed driving has been developed, a pneumatic tire that provides high-speed driving performance is required for not only a high-performance vehicle but also a general passenger vehicle. The pneumatic tire for such high-speed driving is primarily required to provide excellent steering stability and tire durability. However, a recent demand for improvement in fuel economy performance for the purpose of reducing a load on the global environment, in other words, reduction in rolling resistance has also been made in the above-described pneumatic tire for high-speed driving.

To reduce the rolling resistance of a pneumatic tire, in a rubber composition for a tire, heat build-up is reduced by increasing the particle size of carbon black, reducing the blended amount of carbon black, or blending silica (for example, see Patent Document 1). However, these methods have a concern that rubber hardness is decreased and steering stability is insufficient, and tire durability is insufficient due to decreased fatigue resistance, and thus are particularly difficult to apply to a rubber composition used in a pneumatic tire for high-speed driving.

### CITATION LIST

### Patent Literature

Patent Document 1: JP 2013-177113 A

### SUMMARY OF INVENTION

### Technical Problem

An object of the present invention is to provide a pneumatic tire that provides enhanced fuel economy performance beyond conventional levels while maintaining steering stability and tire durability at high speeds, and a method for manufacturing a rubber composition for a tire used for the same.

### Solution to Problem

A pneumatic tire according to an embodiment of the present invention that achieves the above-described object includes a cap tread portion, an undertread portion, and a belt cover layer from outside to inside in a tire radial direction, a rubber composition for an undertread forming the undertread portion includes from 40 to 80 parts by mass of silica blended in 100 parts by mass of diene rubber containing 70 mass % or greater of natural rubber and/or isoprene rubber, and includes a silane coupling agent blended by an amount from 2 to 15 mass % with respect to the silica, a ratio (S_{UT}/M_{UT}) of a tensile strength at break (S_{UT}) to 300% deformation tensile stress (M_{UT}) is 1.80 or more, and an absolute value |M_{UT}-M_{BC}| of difference between the 300% deformation tensile stress (M_{UT}) and 300% deformation tensile stress (M_{BC}) of a rubber composition for a belt cover forming the belt cover layer is 3.0 MPa or less.

A method for manufacturing a rubber composition for a tire according to an embodiment of the present invention is a method for manufacturing a rubber composition for a tire forming the undertread portion of the above-described pneumatic tire, the method including feeding silica and a silane coupling agent into a mixer together, mixing, and then feeding diene rubber, followed by kneading, in a case of manufacturing a rubber composition including 40 parts by mass or more and less than 80 parts by mass of the silica blended in 100 parts by mass of the diene rubber containing 50 mass % or greater of natural rubber and/or isoprene rubber, and including the silane coupling agent blended by an amount from 2 to 15 mass % with respect to the silica amount.

### Advantageous Effects of Invention

A pneumatic tire according to an embodiment of the present invention can provide enhanced fuel economy performance beyond levels in the related art while maintaining steering stability and tire durability at high speeds due to a rubber composition for an undertread that includes natural rubber and/or isoprene rubber and silica, and that has a specific ratio (S_{UT}/M_{UT}) of tensile strength at break (S_{UT}) to 300% deformation tensile stress (M_{UT}) and a specific absolute value |M_{UT}-M_{BC}| of difference between the 300% deformation tensile stress (M_{UT}) and 300% deformation tensile stress (M_{BC}) of a rubber composition for a belt cover.

The rubber composition for an undertread may further include carbon black, and a mass ratio of the silica to total mass of the silica and carbon black may be preferably 0.4 or greater. Thus, more excellent fuel economy performance and more excellent tire durability can be provided.

In the manufacturing method according to an embodiment of the present invention, the whole amount of the silica and the silane coupling agent is fed into a mixer and mixed, and then diene rubber containing natural rubber and/or isoprene rubber as a main component is fed and kneaded. Thus, the silica and the silane coupling agent are easily brought into contact with each other. In addition, after the temperature of the mixer is lowered and the diene rubber is fed, high shear force is applied. Thus, further better dispersibility of silica can be provided, and a rubber composition for a tire that provide excellent mechanical properties and excellent low heat build-up can be obtained. Additionally, in the manufacturing method according to an embodiment of the present invention, unexpectedly, mastication of natural rubber can be omitted, and more excellent mechanical properties of the rubber composition for a tire can be provided simultaneously with an increase in productivity.

In the manufacturing method according to an embodiment of the present invention, together with the silica and the silane coupling agent, carbon black and/or aroma oil can be fed and mixed.

### BRIEF DESCRIPTION OF DRAWINGS

FIG. 1 is a partial cross-sectional view illustrating an example of a pneumatic tire according to an embodiment of the present invention in a tire meridian direction.

### DESCRIPTION OF EMBODIMENTS

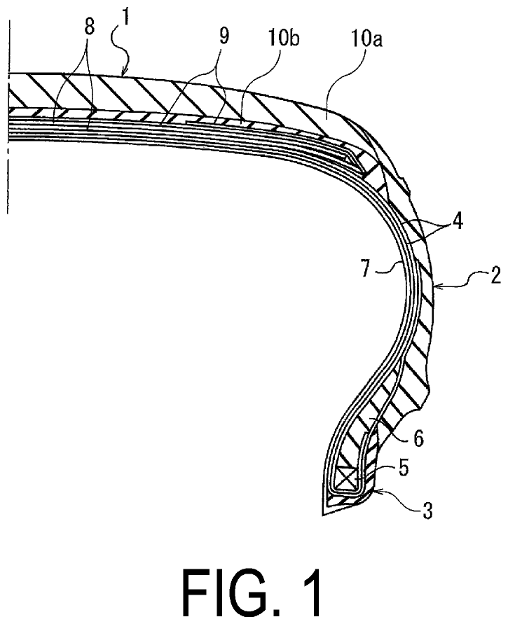

FIG. 1 is a cross-sectional view illustrating an example of a pneumatic tire according to an embodiment. The pneumatic tire includes a tread portion 1, a side wall portion 2, and a bead portion 3.

In FIG. 1, two carcass layers 4 in which reinforcing cords extending in the tire radial direction are arranged at a predetermined interval in the tire circumferential direction and are embedded in a rubber layer extend between left and right side bead portions 3, and both ends of the two carcass layers 4 are folded back from the inside to the outside in the tire axial direction around a bead core 5 embedded in each of the bead portions 3, and sandwich a bead filler 6. An innerliner layer 70 is disposed inward of the carcass layers 4. Two belt layers 8 in which reinforcing cords extending and inclining in the tire circumferential direction are arranged at a predetermined interval in the tire axial direction and are embedded in the rubber layer are disposed circumferentially outward of the carcass layers 4 of the tread portion 1. The reinforcing cords of the two belt layers 8 are arranged in a criss-cross manner with opposite inclination directions with respect to the tire circumferential direction. A belt cover layer 9 is disposed circumferentially outward of the belt layers 8. The tread portion 1 is disposed circumferentially outward of the belt cover layer 9, and includes a cap tread portion 10a and an undertread portion 10b.

In the present specification, the pneumatic tire includes the cap tread portion 10a, the undertread portion 10b, and the belt cover layer 9 in this order from the outside to the inside in the tire radial direction. In other words, the pneumatic tire includes the cap tread portion 10a furthest outward in the tire radial direction, and the undertread portion 10b is adjacent to the inside of the cap tread portion 10a. Further, the belt cover layer 9 is adjacent to the inside of the undertread portion 10b. Then, the undertread portion 10b and the belt cover layer 9 are formed of a rubber composition for an undertread and a rubber composition for a belt cover.

In the rubber composition for an undertread, diene rubber contains natural rubber and/or isoprene rubber. The diene rubber contains natural rubber and/or isoprene rubber, and thus the tensile strength at break of the rubber composition for an undertread can be increased. The content of the natural rubber and/or isoprene rubber is 70 mass % or greater, preferably 75 mass % or greater, and more preferably 85 mass % or greater in 100 mass % of the diene rubber. Due to such a content, the tensile strength at break of the rubber composition for an undertread can be increased. Additionally, the content of the natural rubber and/or isoprene rubber may be 100 mass % or less, preferably 95 mass % or less, more preferably 90 mass % or less in 100 mass % of the diene rubber.

The rubber composition for an undertread can contain diene rubber other than natural rubber and isoprene rubber. Examples of the other diene rubber include butadiene rubber, styrene-butadiene rubber, and acrylonitrile-butadiene rubber. The content of the other diene rubber is from 0 to 30 mass %, preferably from 5 to 25 mass %, and more preferably from 10 to 15 mass % in 100 mass % of the diene rubber.

In the rubber composition for an undertread, from 40 to 80 parts by mass of silica is blended in 100 parts by mass of the diene rubber described above. The silica is blended, and thus heat build-up can be suppressed and the rolling resistance of a resulting tire can be reduced. The blended amount of the silica is preferably from 45 to 75 parts by mass, and more preferably from 50 to 70 parts by mass. When the blended amount of the silica is less than 40 parts by mass, heat build-up cannot be suppressed sufficiently. Additionally, when the blended amount of the silica exceeds 80 parts by mass, durability tends to decrease.

The CTAB adsorption specific surface area of the silica is not particularly limited, but is preferably from 80 to 300 m²/g, and more preferably from 100 to 250 m²/g. The CTAB adsorption specific surface area of the silica is set to 80 m²/g or more, and thus the mechanical properties of the rubber composition can be ensured. Additionally, the CTAB adsorption specific surface area of the silica is set to 300 m²/g or less, and thus good wet performance and good low rolling resistance can be provided. In the present specification, the CTAB specific surface area of the silica is a value measured by ISO 5794. Examples of the silica include wet silica (hydrous silicic acid), dry silica (silicic anhydride), calcium silicate, and aluminum silicate, and these may be used alone or in combination of two or more types thereof.

In the rubber composition for an undertread, a silane coupling agent is blended together with the silica, the dispersibility of the silica in the diene rubber can be improved, and the balance between mechanical properties and low rolling resistance can be increased further. The silane coupling agent is blended by an amount from 2 to 15 mass %, preferably from 4 to 12 mass %, and more preferably from 5 to 10 mass % of the silica amount. When the blended amount of the silane coupling agent is less than 2 mass % of the blended amount of the silica, the dispersion of the silica cannot be enhanced sufficiently, and heat build-up increases. When the blended amount of the silane coupling agent is greater than 15 mass % of the blended amount of the silica, the silane coupling agent condenses, and desired hardness and strength of the rubber composition cannot be obtained.

The type of the silane coupling agent is not particularly limited as long as the silane coupling agent is a silane coupling agent that can be used in a rubber composition including silica. Examples of the silane coupling agent include a sulfur-containing silane coupling agent such as bis(3-triethoxysilylpropyl)tetrasulfide, bis(3-triethoxysilylpropyl)disulfide, 3-trimethoxysilylpropyl benzothiazole tetrasulfide, γ-mercaptopropyl triethoxysilane, and 3-octanoylthiopropyl triethoxysilane.

The rubber composition for an undertread can also include other inorganic filler than the silica. Examples of the other inorganic filler include carbon black, clay, talc, calcium carbonate, magnesium oxide, mica, and bituminous coal. Among these, carbon black is preferable.

When the rubber composition for an undertread includes the silica and the carbon black, a mass ratio of the silica to the total mass of the silica and the carbon black is preferably 0.4 or greater, more preferably from 0.5 to 1.0, and even more preferably from 0.6 to 0.9. the mass ratio of silica is set to 0.4 or greater, and thus the heat build-up can be reduced further.

In the pneumatic tire according to an embodiment of the present invention, a ratio (S_{UT}/M_{UT}) of tensile strength at break (S_{UT}) to 300% deformation tensile stress (M_{UT}) of the rubber composition for an undertread is 1.80 or greater, preferably from 1.85 to 2.70, and more preferably from 1.90 to 2.20. When the ratio (S_{UT}/M_{UT}) is less than 1.80, the properties of the rubber composition for an undertread at the time of tensile break is insufficient, and at high speeds, rubber cannot withstand deformation and breaks, and thus tire durability decreases.

In the pneumatic tire according to an embodiment of the present invention, an absolute value |M_{UT}-M_{BC}| of difference between the 300% deformation tensile stress (M_{UT}) of the rubber composition for an undertread and 300% deformation tensile stress (M_{BC}) of a rubber composition for a belt cover is 3.0 MPa or less, preferably from 0.5 to 2.7 MPa, and more preferably from 1.0 to 2.5 MPa. The absolute value |M_{UT}-M_{BC}| of difference in the 300% deformation tensile stress is set to such a range, and thus deformation distortion at high speeds between the undertread portion and the belt cover layer can be suppressed, the occurrence of interlayer peeling can be reduced, and tire durability can be enhanced. In the related art, since silica is not blended in a rubber composition for an undertread, a tack-up sheet is interposed between an undertread portion and a belt cover layer to suppress interlayer peeling. However, the absolute value |M_{UT}-M_{BC}| of difference in the 300% deformation tensile stress is set to 3.0 MPa or less, and thus a tack-up sheet is unnecessary, the weight of a tire is reduced, and rolling resistance can be reduced further. In the present specification, the 300% deformation tensile stress (M_{UT}) of the rubber composition for an undertread and the 300% deformation tensile stress (M_{BC}) of the rubber composition for a belt cover are determined by performing a tensile test on a No. 3 type dumbbell-shaped test piece at a temperature of 20° C. and a tensile speed of 500 mm/min, and measuring tensile stress at 300% elongation in accordance with JIS K6251.

Examples of a rubber component constituting the rubber composition for a belt cover include natural rubber, isoprene rubber, butadiene rubber, styrene-butadiene rubber, and acrylonitrile-butadiene rubber. Preferably, natural rubber, butadiene rubber, and styrene-butadiene rubber are blended. Additionally, in 100 mass % of the rubber component, the natural rubber is preferably from 50 to 90 mass %, more preferably from 60 to 80 mass %, and the butadiene rubber and/or the styrene-butadiene rubber is preferably from 50 to 10 mass %, and more preferably from 40 to 20 mass %.

The rubber composition for a belt cover includes from 30 to 80 parts by mass, preferably from 40 to 70 parts by mass of an inorganic filler blended in 100 parts by mass of the rubber component. Examples of the inorganic filler include carbon black, silica, clay, talc, calcium carbonate, magnesium oxide, mica, and bituminous coal. The inorganic filler in the rubber composition for a belt cover may be the same as or differ from the inorganic filler in the rubber composition for an undertread.

According to an embodiment of the present invention, the rubber composition for an undertread and the rubber composition for a belt cover can contain, in addition to the above-described compounding agents, a compounding agent to be blended in a usual rubber composition for an undertread and a usual rubber composition for a belt cover. In other words, various types of additives generally used in a rubber composition such as a vulcanizing or crosslinking agent, a vulcanization accelerator aid, and an anti-aging agent, a peptizing agent, various types of oil, and a crosslinking agent can be blended in the range that the additives do not inhibit the configuration of the present invention. These additives can be kneaded by a general method to form the rubber composition for an undertread and the rubber composition for a belt cover, and can be used in vulcanization or crosslinking.

Next, a method for manufacturing a rubber composition for a tire that forms the undertread portion 10b will be described. Note that in the following description, the rubber composition for a tire that forms the undertread portion 10b may be referred to simply as a rubber composition for a tire.

In general, a method for manufacturing a rubber composition for a tire includes at least two steps of; a kneading step (mixing step in a first stage) of mixing and kneading diene rubber, silica, a silane coupling agent, carbon black, aroma oil, and a compounding agent excluding a vulcanizing compounding agent; and a step (mixing step in a final stage) of mixing a vulcanizing compounding agent after cooling a mixture obtained at the kneading step. Additionally, when the diene rubber includes natural rubber, a masticating step of masticating the natural rubber is usually performed before the kneading step. In the method for manufacturing a rubber composition for a tire according to an embodiment of the present invention, the above-described kneading step includes at least two steps of: feeding and mixing the whole amount of the silica and the silane coupling agent into a mixer; and, after that step, feeding and kneading the diene rubber into the mixer containing the silica and the silane coupling agent.

In the manufacturing method according to an embodiment of the present invention, the mixing step in the first stage is started by performing the step of feeding and mixing the whole amount of the silica and the silane coupling agent into a mixer. Thus, the silica and the silane coupling agent are easily brought into contact with each other, and the silane coupling agent acts on the silica more effectively. Thus, as compared with the case of the related art where silica is surface-treated at another step, the number of steps can be reduced and a manufacturing cost can be reduced. Additionally, the silica and the silane coupling agent are mixed first, and thus the temperature of the mixer can be decreased, then the temperature during kneading the diene rubber can be lowered, the kneading strength inside the mixer can be increased, and better dispersibility of the silica can be provided. At a mixing step in a first stage in the related art where diene rubber is first fed into a mixer and kneaded and then various types of compounding agents are fed and kneaded, the kneading of the diene rubber increases the temperature inside the mixer and decreases the viscosity of the diene rubber, and thus high shear force cannot be applied when silica is subsequently fed and kneaded. Thus, the silica cannot be dispersed well.

The amounts of the silica and the silane coupling agent to be fed into a mixer is such that the amount of the silane coupling agent is from 2 to 15 mass %, and preferably from 4 to 12 mass % with respect to the silica amount. The blended amount of the silane coupling agent is set to 2 mass % or greater of the silica amount, and thus the dispersion of the silica can be enhanced.

Additionally, the blended amount of the silane coupling agent is set to 15 mass % or less of the silica amount, and thus condensation between the silane coupling agents can be suppressed, and a rubber composition having desired hardness and strength can be obtained.

To mix the silica and the silane coupling agent, a mixer that is usually used for manufacturing a rubber composition for a tire can be used. Additionally, the type of a rotor constituting the mixer may be any of a meshing type or a non-meshing type. The rotation speed of the rotor can be set to a normal rotation speed used in manufacturing a rubber composition for a tire.

According to an embodiment of the present invention, the temperature at which the silica and the silane coupling agent are mixed is preferably from 20 to 90° C., and more preferably from 30 to 70° C. In particular, the maximum temperature in the mixing is set to 70° C., and thus during kneading the diene rubber following that step, shear force can be increased and good dispersibility of the silica can be provided.

The time for mixing the silica and the silane coupling agent can be set to preferably from 5 seconds to 2 minutes, and more preferably from 20 seconds to 90 seconds. The mixing time is set to 20 seconds or more, and thus the silica and the silane coupling agent can be mixed and brought into sufficient contact with each other. Additionally, the mixing time is set to 90 seconds or less, and thus a decrease in productivity can be suppressed.

In the manufacturing method according to an embodiment of the present invention, together with silica and silane coupling agent, carbon black and/or aroma oil can be fed and mixed, and thus rolling resistance can be reduced and wear resistance can be increased. The carbon black and the aroma oil are preferably fed into a mixer simultaneously with the silica and the silane coupling agent. Additionally, the mixing conditions used when the carbon black and the aroma oil are fed can be the same as described above.

According to an embodiment of the present invention, the diene rubber containing natural rubber and/or isoprene rubber as a main component is fed into the mixer in which the silica and the silane coupling agent have been mixed, and is kneaded. The feeding of the diene rubber into the mixer can be performed within the range of usual feeding conditions. Additionally, the conditions for kneading the silica and the silane coupling agent with the diene rubber can be set within a usual range.

The compounding agent excluding the vulcanizing compounding agent, to be blended in the rubber composition for a tire may be fed and kneaded simultaneously with the diene rubber, or may be fed and mixed after the kneading of the diene rubber has been completed. Examples of the compounding agent excluding the vulcanizing compounding agent include various types of additives generally used in a rubber composition for a tire, such as an anti-aging agent, a plasticizer, a processing aid, a liquid polymer, a terpene resin, and a thermosetting resin. These compounding agents can be blended by a general compounding amount of the related art, as long as the compounding agents do not contradict the object of the present invention. For example, a filler other than silica, such as carbon black, may be fed and kneaded simultaneously with the feeding of the diene rubber, and a so-called rubber agent such as zinc oxide, stearic acid, and an anti-aging agent may be fed and kneaded simultaneously with the feeding of the diene rubber, or aroma oil may be fed and mixed after the kneading of the diene rubber has been completed.

According to an embodiment of the present invention, after the kneading step (mixing step in the first stage) of mixing and kneading diene rubber, silica, a silane coupling agent, carbon black, aroma oil, and a compounding agent excluding a vulcanizing compounding agent, the obtained mixture is cooled, and the step (mixing step in the final stage) of mixing the vulcanizing compounding agent is performed. Examples of the vulcanizing compounding agent include a vulcanizing or crosslinking agent, a vulcanization accelerator, and a vulcanization retarder. A method for mixing the vulcanizing compounding agent can be performed in the same manner as in a usual method for manufacturing a rubber composition for a tire.

The rubber composition for a tire manufactured according to an embodiment of the present invention includes 40 parts by mass or greater and less than 80 parts by mass of silica blended in 100 parts by mass of diene rubber including 50 mass % or greater of natural rubber and/or isoprene rubber, and from 2 to 15 mass % of a silane coupling agent blended with respect to the silica amount.

The rubber composition for a tire includes 50 mass % or greater of natural rubber and/or isoprene rubber in 100 mass % of diene rubber. The rubber composition includes the natural rubber and/or the isoprene rubber, and thus the mechanical properties of the rubber composition for a tire can be increased further. The content of the natural rubber and/or the isoprene rubber may be set to preferably from 50 to 100 mass %, more preferably from 55 to 90 mass %, and even more preferably from 60 to 85 mass % in 100 mass % of the diene rubber. When the content of the natural rubber and/or the isoprene rubber is less than 50 mass %, the effect of increasing mechanical properties cannot be obtained sufficiently.

In the manufacturing method according to an embodiment of the present invention, unexpectedly, the mastication step of natural rubber can be omitted. Thus, since equipment, time, and labor required for the mastication step can be omitted, productivity can be increased. Additionally, the rubber composition obtained by the manufacturing method in which the mastication step of natural rubber is omitted can obtain mechanical properties equivalent to or better than the mechanical properties of a rubber composition obtained by a manufacturing method of the related art including a mastication step of natural rubber. Examples of an indicator of the breaking energy of the rubber composition include a tensile product (product of tensile strength at break and tensile elongation at break). The manufacturing method according to an embodiment of the present invention is applied, and thus a rubber composition for a tire having a tensile product beyond conventional levels can be obtained.

The rubber composition for a tire can include other diene rubber than natural rubber and isoprene rubber. Examples of the other diene rubber include butadiene rubber, styrene-butadiene rubber, styrene-isoprene rubber, styrene-isoprene-butadiene rubber, and acrylonitrile-butadiene rubber. These types of diene rubber may be modified diene rubber in which the terminal and/or side chain of the molecular chain is modified by an epoxy group, a carboxy group, an amino group, a hydroxy group, an alkoxy group, a silyl group, or an amide group.

Examples of the silica include wet silica (hydrous silicic acid), dry silica (silicic anhydride), calcium silicate, and aluminum silicate. These may be used alone or in combination of two or more types thereof. Additionally, surface-treated silica obtained by treating a surface of silica with a silane coupling agent may be used.

The CTAB adsorption specific surface area of the silica is not particularly limited, but is preferably from 80 to 300 m²/g, and more preferably from 100 to 250 m²/g. The CTAB adsorption specific surface area of the silica is set to 80 m²/g or more, and thus the mechanical properties and the wear resistance of the rubber composition can be ensured. Additionally, the CTAB adsorption specific surface area of the silica is set to 300 m²/g or less, and thus good low heat build-up can be provided. In the present specification, the CTAB specific surface area of the silica is a value measured in accordance with ISO 5794.

The blended amount of the silica is 40 parts by mass or more and less than 80 parts by mass, preferably from 45 to 75 parts by mass, and more preferably from 50 to 70 parts by mass with respect to 100 parts by mass of the diene rubber. The blended amount of the silica is set to 40 parts by mass or more, and thus durability can be improved. Additionally, the blended amount of the silica is set to less than 80 parts by mass, low heat build-up can be enhanced.

The silane coupling agent is not particularly limited as long as the silane coupling agent can be used for a rubber composition including silica, and examples of the silane coupling agent include a sulfur-containing silane coupling agent and an amino group-containing silane coupling agent. Examples of the sulfur-containing silane coupling agent include bis-(3-triethoxysilylpropyl)tetrasulfide, bis(3-triethoxysilylpropyl)disulfide, 3-trimethoxysilylpropylbenzothiazoletetrasulfide, γ-mercaptopropyltriethoxysilane, and 3-octanoylthiopropyl triethoxysilane. Examples of the amino group-containing silane coupling agent include 3-aminopropyltrimethoxysilane, 3-aminopropyltriethoxysilane, N-2-(aminoethyl)-3-aminopropylmethyldimethoxysilane, N-2-(aminoethyl)-3-aminopropyltrimethoxysilane, 3-triethoxysilyl-N-(1,3-dimethyl-butylidene)propylamine, N-phenyl-3-aminopropyltrimethoxysilane, and hydrochloride of N-(vinylbenzyl)-2-aminoethyl-3-aminopropyltrimethoxysilane.

The blended amount of the silane coupling agent is from 2 to 15 mass %, and preferably from 4 to 12 mass % with respect to the weight of the silica. The blended amount of the silane coupling agent is set to 2 mass % or greater of the silica amount, dispersion of the silica can be enhanced. Additionally, the blended amount of the silane coupling agent is set to 15 mass % or less of the silica amount, condensation between the silane coupling agents can be suppressed, and a rubber composition having desired hardness and strength can be obtained.

In the rubber composition for a tire manufactured according to an embodiment of the present invention, together with the silica and the silane coupling agent, carbon black and/or aroma oil can be blended.

Examples of the carbon black include furnace carbon black such as SAF, ISAF, HAF, FEF, GPF, HMF, and SRF. These may be used alone or in combination of two or more types thereof. The nitrogen adsorption specific surface area of the carbon black is not particularly limited, but may be set to preferably from 70 to 240 m²/g, and more preferably from 90 to 200 m²/g. The nitrogen adsorption specific surface area of the carbon black is set to 70 m²/g or greater, and thus the mechanical properties and the wear resistance of the rubber composition can be ensured. Additionally, the nitrogen adsorption specific surface area of the carbon black is set to 240 m²/g or less, good low heat build-up can be provided. In the present specification, the nitrogen adsorption specific surface area of the carbon black is measured in accordance with JIS K6217-2.

The blended amount of the carbon black can be set to preferably from 5 to 100 parts by mass, and more preferably from 10 to 80 parts by mass with respect to 100 parts by mass of the diene rubber. The blended amount of the carbon black is set to 5 parts by mass or more, the mechanical properties and the wear resistance of the rubber composition can be ensured. Additionally, the blended amount of the carbon black is set to 100 parts by mass or less, low heat build-up can be ensured.

The rubber composition for a tire can include other filler than silica and carbon black. Examples of the other filler include calcium carbonate, magnesium carbonate, talc, clay, alumina, aluminum hydroxide, titanium oxide, and calcium sulfate. These may be used alone or in combination of two or more types thereof.

As the aroma oil, for example, aroma oil having a mass percentage of an aromatic hydrocarbon of 15 mass % or more determined in accordance with ASTM D2140 is preferably used. In other words, aroma oil including the molecular structure that can contain aromatic hydrocarbon, paraffinic hydrocarbon, or naphthenic hydrocarbon, and having a content ratio of aromatic hydrocarbon of preferably 15 mass % or more, and more preferably 17 mass %. Additionally, the content ratio of the aromatic hydrocarbon in the aroma oil is preferably 70 mass % or less, and more preferably 65 mass % or less.

Examples of commercially available aroma oil include Extract No. 4S available from Showa Shell Sekiyu KK, AC-12, AC-460, AH-16, AH-24, AH-58 available from Idemitsu Kosan Co., Ltd., and Process NC300S and Process X-140 available from Japan Energy Corporation.

In the rubber composition for a tire, the blended amount of the aroma oil is preferably from 3 to 50 parts by mass, and more preferably from 5 to 40 parts by mass with respect to 100 parts by mass of the diene rubber. The blended amount of the aroma oil is set to 3 parts by mass or more, and thus good processability can be ensured. Additionally, the blended amount of the aroma oil is set to 50 parts by mass or less, wear resistance can be ensured.

Embodiments according to the present invention will further be described below in examples. However, the scope of the embodiments of the present invention is not limited to these examples.

### EXAMPLE

Eleven types of rubber compositions for an undertread (Examples 1 to 6 and Comparative Examples 1 to 5) having the common compounding proportion shown in Table 2 and having the compounding proportion shown in Table 1 are prepared. In the compounding proportion of each one of the rubber compositions for an undertread, components excluding sulfur and a vulcanization accelerator were weighed and kneaded for about 5 minutes with a 1.7 L sealed Banbury mixer, and the obtained mixture was discharged and cooled at room temperature. The cooled mixture was applied to a roll, and sulfur and a vulcanization accelerator were added, and mixed to prepare a rubber composition for an undertread. Note that the mass ratio of silica to the total mass of silica and carbon black is described in parentheses in the column of “Silica mass ratio (-)”.

As for two types of rubber compositions for a belt cover (compositions B1 and B2) having the compounding proportion shown in Table 3, components excluding sulfur and a vulcanization accelerator were weighed and kneaded for about 5 minutes with a 1.7 L sealed Banbury mixer, and the obtained mixture was discharged and cooled to room temperature. The cooled mixture was applied to a roll, sulfur and a vulcanization accelerator were added, and mixed, to prepare a rubber composition for a belt cover.

With use of the obtained rubber composition for an undertread and the obtained rubber composition for a belt cover, test samples were prepared by performing vulcanization molding at 160° C. for 30 minutes by using a mold having a predetermined shape, and 300% tensile stress and tensile strength at break were measured by methods described below. Additionally, with use of a test sample of the rubber composition for an undertread, tan δ at 60° C. was measured.

### 300% Tensile Stress

From the obtained test sample, a JIS No. 3 dumbbell-shaped test piece was cut out in accordance with JIS K6251. A tensile test was performed at a temperature of 20° C. and a tensile speed of 500 mm/min in accordance with JIS K6251, and tensile stress at 300% elongation and tensile strength at break were measured. Table 3 shows tensile stress at 300% elongation (M_{BC}) of the rubber composition for a belt cover. Tensile strength at break (S_{UT}) of the rubber composition for an undertread is shown in Table 1 as an index value with Comparative Example 1 being assigned the value of 100. A larger index value of the tensile strength at break means more excellent durability. Additionally, a ratio (S_{UT}/M_{UT}) of the tensile strength at break (S_{UT}) to 300% deformation tensile stress (M_{UT}) of the rubber composition for an undertread was calculated, and described in the column of “S_{UT}/M_{UT}” of Table 1. Further, difference (M_{UT}-M_{BC}) between the 300% deformation tensile stress (M_{UT}) of the rubber composition for an undertread and the 300% deformation tensile stress (M_{BC}) of the rubber composition for a belt cover was calculated, and described in the column of “M_{UT}-M_{BC}” of Table 1.

### Tan δ at 60° C. (Fuel Economy Performance)

The dynamic visco-elasticity of the obtained test sample was measured by using a viscoelasticity spectrometer available from Toyo Seiki Seisaku-sho, Ltd. at initial strain of 10%, an amplitude of ±2%, and a frequency of 20 Hz, and the tan δ at a temperature of 60° C. was determined. The reciprocal of each of the obtained results of tan δ at 60° C. was calculated, and was described in the column of “Fuel economy performance” of Table 1 as an index value with Comparative Example 1 being assigned the value of 100. A larger index value of fuel economy performance means lower heat build-up, lower rolling resistance of a resulting tire, and more excellent fuel economy performance.

As shown in Table 1, 11 types of rubber compositions for an undertread (Examples 1 to 6 and Comparative Examples 1 to 5) were combined with two types of rubber compositions for a belt cover (compositions B1 and B2), and vulcanization molding was performed to obtain pneumatic tires having a tire size (195/65R15). A tread portion of each one of the obtained pneumatic tires was disassembled, and peel strength (N/5 cm) in peeling an undertread portion from a belt cover layer was measured. The obtained results are described in the column of “Interlayer peel strength” of Table 1 as index values with Comparative Example 1 being assigned the value of 100. A larger index value of the interlayer peel strength means higher adhesiveness between the undertread portion and the belt cover layer, and more excellent tire durability.

TABLE 1

| | | Comparative | Comparative | Comparative | Comparative | Comparative | |
|---|---|---|---|---|---|---|---|
| | | Example 1 | Example 2 | Example 3 | Example 4 | Example 5 | Example 1 |
| NR | Part by | 80 | 80 | 80 | 60 | 80 | 80 |
| | mass | | | | | | |
| BR | Part by | 20 | 20 | 20 | 40 | 20 | 20 |
| | mass | | | | | | |
| Carbon | Part by | 80 | 70 | 10 | 10 | 10 | 10 |
| black | mass | | | | | | |
| Silica | Part by | 0 | 10 | 70 | 70 | 70 | 70 |
| | mass | | | | | | |
| Coupling | Part by | 0 | 0.8 | 0 | 5.6 | 5.6 | 5.6 |
| agent-1 | mass | | | | | | |
| Silica mass | (—) | 0.0 | 0.13 | 0.88 | 0.88 | 0.88 | 0.88 |
| ratio | | | | | | | |
| S_{UT}/M_{UT} | (—) | 1.18 | 1.38 | 2.23 | 1.73 | 2.12 | 2.12 |
| Type of | | Composition | Composition | Composition | Composition | Composition | Composition |
| rubber | | B1 | B1 | B1 | B1 | B2 | B1 |
| composition | | | | | | | |
| for belt cover | | | | | | | |
| M_{UT} − M_{BC} | MPa | 7 | 5.4 | −1.4 | −0.2 | −4.5 | −0.6 |
| Fuel | Index | 100 | 101 | 98 | 109 | 108 | 108 |
| economy | value | | | | | | |
| performance | | | | | | | |
| Tensile | Index | 100 | 108 | 110 | 94 | 112 | 112 |
| strength at | value | | | | | | |
| break (S_{UT}) | | | | | | | |
| Interlayer | Index | 100 | 98 | 102 | 94 | 98 | 103 |
| peel | value | | | | | | |
| strength | | | | | | | |

| | | Example 2 | Example 3 | Example 4 | Example 5 | Example 6 |
|---|---|---|---|---|---|---|
| NR | Part by | 80 | 80 | 80 | 80 | 80 |
| | mass | | | | | |
| BR | Part by | 20 | 20 | 20 | 20 | 20 |
| | mass | | | | | |
| Carbon | Part by | 40 | 10 | 10 | 0 | 10 |
| black | mass | | | | | |
| Silica | Part by | 40 | 70 | 70 | 80 | 70 |
| | mass | | | | | |
| Coupling | Part by | 3.2 | 1.4 | 10.5 | 6.4 | 5.6 |
| agent-1 | mass | | | | | |
| Silica mass | (—) | 0.50 | 0.88 | 0.88 | 1.00 | 0.88 |
| ratio | | | | | | |
| S_{UT}/M_{UT} | (—) | 1.83 | 1.95 | 1.98 | 1.99 | 1.83 |
| Type of | | Composition | Composition | Composition | Composition | Composition |
| rubber | | B1 | B1 | B1 | B1 | B2 |
| composition | | | | | | |
| for belt cover | | | | | | |
| M_{UT} − M_{BC} | MPa | 1 | 0.6 | 1 | 0.8 | −2.9 |
| Fuel | Index | 106 | 101 | 110 | 109 | 106 |
| economy | value | | | | | |
| performance | | | | | | |
| Tensile | Index | 109 | 113 | 118 | 117 | 109 |
| strength at | value | | | | | |
| break (S_{UT}) | | | | | | |
| Interlayer | Index | 101 | 104 | 101 | 103 | 104 |
| peel | value | | | | | |
| strength | | | | | | |

Types of raw materials used and indicated in Table 1 are described below.

NR: natural rubber, TSR20, Tg: −65° C.

BR: butadiene rubber, Nipol BR1220, available from ZEON CORPORATION, Tg: −105° C.

Carbon black: Niteron #300IH, available from NSCC Carbon Co., Ltd., nitrogen adsorption specific surface area: 115 m²/g

Silica: Uitrasil VN3, available from Degussa, CTAB adsorption specific surface area: 153 m²/g

Coupling agent: sulfur-containing silane coupling agent, Si69, available from Evonik Degussa Corporation

TABLE 2
Common compounding proportion of
rubber composition for undertread

| | |
|---|---|
| Zinc oxide | 3.0 Part by mass |
| Stearic acid | 1.0 Part by mass |
| Anti-aging agent | 2.0 Part by mass |
| Sulfur | 4.0 Part by mass |
| Vulcanization accelerator | 2.0 Part by mass |

The types of raw materials used and indicated in Table 2 are described below.

Zinc oxide: Zinc Oxide III, available from Seido Chemical Industry Co., Ltd.

Stearic acid: beads stearic acid, available from NOF Corporation

Anti-aging agent: Santoflex 6PPD, available from Flexsys

Sulfur: MUCRON OT-20, available from Shikoku Chemicals Corporation

Vulcanization accelerator: NOCCELER CZ, available from Ouchi Shinko Chemical Industrial Co., Ltd.

TABLE 3

| | | Composition | Composition |
|---|---|---|---|
| Rubber composition for belt cover | | B1 | B2 |
| NR | Part by mass | 70 | 70 |
| SBR | Part by mass | 30 | 30 |
| Carbon black | Part by mass | 50 | 60 |
| Zinc oxide | Part by mass | 3 | 3 |
| Stearic acid | Part by mass | 1 | 1 |
| Anti-aging agent | Part by mass | 2 | 2 |
| Sulfur | Part by mass | 4 | 4 |
| Vulcanization accelerator | Part by mass | 2 | 2 |
| Oil | Part by mass | 20 | 20 |
| 300% tensile stress (M_{BC}) | MPa | 13.0 | 16.9 |

Types of raw materials used and indicated in Table 3 are described below.

NR: natural rubber, TSR20, Tg: −65° C.

SBR: styrene-butadiene rubber, Nipol 1502, available from ZEON CORPORATION, Tg: −60° C.

Carbon black, SEAST V, available from Tokai Carbon Co., Ltd., nitrogen adsorption specific surface area: 27 m²/g

Zinc oxide: Zinc Oxide III, available from Seido Chemical Industry Co., Ltd.

Stearic acid: beads stearic acid, available from NOF Corporation

Anti-aging agent: Santoflex 6PPD, available from Flexsys

Sulfur: MUCRON OT-20, available from Shikoku Chemicals Corporation

Vulcanization accelerator: NOCCELER CZ, available from Ouchi Shinko Chemical Industrial Co., Ltd.

As can be seen clearly from Table 1, the pneumatic tires of Examples 1 to 6 provide excellent fuel economy performance, excellent steering stability, and excellent tire durability.

In the pneumatic tire of Comparative Example 2, the rubber composition for an undertread includes less than 40 parts by mass of silica, a ratio (Su_{T}/Mu_{T}) of tensile strength at break to 300% deformation tensile stress is less than 1.80 and an absolute value |M_{UT}-M_{BC}| of difference in the 300% deformation tensile stress exceeds 3.0 MPa. Thus, the peel strength between the undertread portion and the belt cover layer is low.

In the pneumatic tire of Comparative Example 3, since the rubber composition for an undertread includes no silane coupling agent, fuel economy performance cannot be enhanced.

In the pneumatic tire of Comparative Example 4, a natural rubber content of is less than 70 mass % in the rubber composition for an undertread, and a ratio (S_{UT}/M_{UT}) of tensile strength at break and 300% deformation tensile stress is less than 1.80. Thus, the peel strength between the undertread portion and the belt cover layer is low.

In the pneumatic tire of Comparative Example 5, an absolute value |M_{UT}-M_{B}| of difference in 300% deformation tensile stress is greater than 3.0 MPa, and thus the peel strength between the undertread portion and the belt cover layer is low.

Next, a method for manufacturing a rubber composition for a tire forming an undertread portion will be described.

As for rubber compositions 1 and 2 having the compounding proportion shown in Table 5, methods for manufacture rubber compositions for a tire differed. In the compounding proportion of each of the rubber compositions of Table 5, the blended amount with respect to 100 parts by mass of diene rubber was described, and the abbreviation of each component and whether a component was fed into a mixer at the mixing step in any of the first stage or the final stage. At the mixing in the first stage, the total amount of each component described in the column of “Mixing in first stage” of Table 5 was fed into a mixer (1.7 liter sealed Banbury mixer, available from Kobe Steel Ltd.) in the order shown in Table 4 and kneaded to obtain a kneaded product. The kneaded product was discharged from the mixer and cooled. After cooling, the kneaded product was again fed into the mixer, and the components described in the column of “Mixing in final stage” of Table 5 were fed and mixed to prepare a rubber composition by nine types of manufacturing methods (Examples 7 to 12, standard example, and Comparative Examples 6 to 7).

In a state where the temperature of the Banbury mixer is set to 60° C., the mixing of the various raw materials having room temperature (23° C.) is started. Table 4 shows, as the mixing conditions, the mixing time and the temperature obtained after the completion of the mixing of the component fed first, and the initial mixing temperature of the component fed second. The mixing time of the components fed second and third was 1 minute. Note that a kneaded product obtained in the mixing in the first stage was cooled to 23° C. by air cooling outside the machine, and after blending of a vulcanizing agent, the mixing was performed for 1.5 minutes by using a Banbury mixer.

In the above-described manufacturing method, a manufacturing method of the standard example included mastication of natural rubber for 1.5 minutes before the mixing step in the first stage. In other manufacturing methods of Examples 7 to 12 and Comparative Examples 6 to 7, no mastication step was performed. As for the standard example, a total of 5.5 minutes of the mastication step (1.5 minutes), the mixing step in the first stage (mixing time of the first feeding: 0.5 minutes, mixing time of the second feeding: 1 minute, and mixing time of the third feeding: 1 minute) and the final step (1.5 minutes) is the time required for kneading. Similarly, as for Examples 7 to 12 and Comparative Examples 6 to 7, the total kneading time of the mixing step in the first stage (mixing time of the first feeding: described in Table 4, mixing time of the second feeding: 1 minute, mixing time of the third feeding: 1 minute) and the final step (1.5 minutes) was determined. Based on the obtained kneading time, a productivity index value was determined based on the following formula.

(Productivity index value)=(kneading time of standard example)/(kneading time of each example)×100

The calculated productivity index value is described in the column of “Productivity” of Table 5. A larger index value means shorter kneading time and more excellent productivity.

The obtained rubber composition for a tire was vulcanized at 170° C. for 10 minutes by using a mold having a predetermined shape (inner dimension; length 150 mm, width 150 mm, and thickness 2 mm) to prepare a vulcanized rubber test piece. With use of the obtained vulcanized rubber test piece, the degree of silica dispersion, rolling resistance, and a tensile product were measured by test methods described below.

### Degree of Silica Dispersion

The degree of silica dispersion of the obtained vulcanized rubber test piece was measured by using a DisperGrader 1000 available from OptiGrade in accordance with the method B of ISO 11345. The degree of silica dispersion was evaluated as an X value. The obtained value is described in the column of “Degree of silica dispersion” of Table 4 as an index value with the standard example being assigned the value of 100. A larger index value of the degree of silica dispersion means better dispersibility of silica.

### Rolling Resistance [tan δ at 60° C.]

The dynamic visco-elasticity of the obtained vulcanized rubber test piece was measured by using a viscoelasticity spectrometer available from Iwamoto Seisakusho Co., Ltd. under the conditions of elongation deformation strain of 10 ±2%, a vibration frequency of 20 Hz, and a temperature of 60° C., and the tan δ (60° C.) was determined. The reciprocal of each of the obtained results was calculated, and was described in the column of “Rolling Resistance” of Table 4 as an index value with the standard example being assigned the value of 100. Additionally, a larger index value of the rolling resistance means a smaller tan δ (60° C.), lower heat build-up, lower rolling resistance of a resulting tire, and more excellent fuel economy performance.

### Tensile Product

With use of the obtained vulcanized rubber test piece, a dumbbell-shaped JIS No. 3 type test piece was produced in accordance with JIS K6251. With use of the obtained test piece, a tensile testing was performed at room temperature (23° C.) at a tensile speed of 500 mm/min to measure tensile strength at break and tensile elongation at break. The product of the obtained tensile strength at break and the obtained tensile elongation at break was calculated as a tensile product. The value of the obtained tensile product was described in the column of “Tensile product” of Table 4 as an index value with the standard example being assigned the value of 100. A larger index value means a higher tensile product, and more excellent mechanical properties.

TABLE 4

| | | Standard | Comparative | Comparative | | |
|---|---|---|---|---|---|---|
| Mixing in first stage | | Example | Example 6 | Example 7 | Example 7 | Example 8 |
| First Feeding | | NR/BR | NR/BR | Silica | Silica | Silica |
| | | | | | Coupling | Coupling |
| | | | | | agent | agent |
| Mixing time | Minute | 0.5 | 0.5 | 0.5 | 0.5 | 1 |
| Mixing completion | ° C. | 80 | 80 | 50 | 45 | 45 |
| temperature | | | | | | |
| Second feeding | | Silica | Treated | NR/BR | NR/BR | NR/BR |
| | | Coupling | silica | Coupling | CB | CB |
| | | agent | CB | agent | Rubber | Rubber |
| | | CB | Rubber | CB | agent | agent |
| | | Rubber | agent | Rubber | | |
| | | agent | | agent | | |
| Mixing start | ° C. | 80 | 80 | 50 | 45 | 45 |
| temperature | | | | | | |
| Third feeding | | Aroma oil | Aroma oil | Aroma oil | Aroma oil | Aroma oil |
| Degree of silica | Index | 100 | 98 | 99 | 106 | 107 |
| dispersion | value | | | | | |
| Rolling resistance | Index | 100 | 97 | 98 | 105 | 106 |
| | value | | | | | |
| Tensile product | Index | 100 | 96 | 98 | 102 | 102 |
| | value | | | | | |
| Productivity | Index | 100 | 138 | 138 | 138 | 122 |
| | value | | | | | |

| | | | Example | Example | Example |
|---|---|---|---|---|---|
| Mixing in first stage | | Example 9 | 10 | 11 | 12 |
| First Feeding | | Silica | Silica | Silica | Silica |
| | | Coupling | Coupling | Coupling | Coupling |
| | | agent | agent | agent | agent |
| | | | Aroma oil | CB | Aroma oil |
| | | | | | CB |
| Mixing time | Minute | 1.5 | 0.5 | 0.5 | 0.5 |
| Mixing com- | ° C. | 45 | 40 | 45 | 40 |

| pletion temperature | | | | | |
|---|---|---|---|---|---|
| Second feeding | | NR/BR | NR/BR | NR/BR | NR/BR |
| | | CB | CB | Rubber | Rubber |
| | | Rubber | Rubber | agent | agent |
| | | agent | agent | | |
| Mixing start | ° C. | 45 | 40 | 45 | 40 |
| temperature | | | | | |
| Third feeding | | Aroma oil | Aroma oil | | |
| Degree of silica | Index | 108 | 105 | 105 | 104 |
| dispersion | value | | | | |
| Rolling resistance | Index | 106 | 105 | 104 | 103 |
| | value | | | | |
| Tensile product | Index | 103 | 102 | 102 | 101 |
| | value | | | | |
| Productivity | Index | 110 | 138 | 138 | 138 |
| | value | | | | |

TABLE 5

| | | | | Rubber | Rubber |
|---|---|---|---|---|---|
| | | Abbreviations | | composition 1 | composition 2 |
| Mixing in | Silica | Silica | Part by mass | 60 | — |
| first stage | Surface-treated | Silica | Part by mass | — | 60 |
| | silica | | | | |
| | Silane coupling | Coupling | Part by mass | 6 | — |
| | agent | agent | | | |
| | Natural rubber | NR | Part by mass | 70 | 70 |
| | Butadiene rubber | BR | Part by mass | 30 | 30 |
| | Carbon black | CB | Part by mass | 20 | 20 |
| | Aroma oil | Aroma oil | Part by mass | 20 | 20 |
| | Zinc oxide | Rubber agent | Part by mass | 3 | 3 |
| | Stearic acid | | Part by mass | 1 | 1 |
| | Anti-aging | | Part by mass | 1.5 | 1.5 |
| | agent 1 | | | | |
| Mixing in | Sulfur | Vulcanizing | Part by mass | 1.5 | 1.5 |
| final stage | Vulcanization | agent | Part by mass | 1.5 | 1.5 |
| | accelerator 1 | | | | |

The types of raw materials used and indicated in Table 5 are as follows.

Silica: Ultrasil VN3, available from Degussa, CTAB adsorption specific surface area: 153 m²/g

Surface-treated silica: silica obtained by surface-treating Si69 available from Evonik Degussa Corporation (Ultrasil VN3 available from Degussa) at a rate of 10 mass %.

Silane coupling agent: sulfide-based silane coupling agent, Si69, available from Evonik Degussa Corporation

Natural rubber: NR, TSR 20, glass transition temperature: −65° C. Butadiene rubber: BR, Nipol BR1220, available from Zeon Corporation, glass transition temperature: −105° C.

Carbon black: CB, Niteron#300IH, available from NSCC Carbon Co., Ltd., nitrogen adsorption specific surface area: 115 m²/g

Aroma oil: Extract No. 4S, available from Showa Shell Sekiyu K.K.

Zinc oxide: Zinc Oxide III, available from Seido Chemical Industry Co., Ltd.

Stearic acid: stearic acid, available from NOF Corporation

Anti-aging agent: Santoflex 6PPD, available from Flexsys

Sulfur: MUCRON OT-20, available from Shikoku Chemicals Corporation

Vulcanization accelerator 1: NOCCELER CZ-G (CZ), available from Ouchi Shinko Chemical Industrial Co., Ltd.

As can be seen clearly from Table 4, the rubber compositions obtained by the manufacturing methods of Examples 7 to 12 provide an enhanced degree of silica dispersion, enhanced low heat build-up (tan δ at 60° C.), an enhanced tensile product, and enhanced productivity.

In the rubber composition obtained in Comparative Example 6, surface-treated silica was blended in place of silica in the standard example. The mixer temperature rises due to the first feeding, and thus the degree of silica dispersion and low rolling resistance cannot be enhanced sufficiently.

In the rubber composition obtained in Comparative Example 7, in the mixing in the first stage, only silica was fed first into the mixer and mixed, and no silane coupling agent was fed first. Thus, the silica and the silane coupling agent did not sufficiently react with each other, and the degree of silica dispersion and low rolling resistance cannot be enhanced sufficiently. Additionally, a tensile product cannot also be enhanced.

### REFERENCE SIGNS LIST

1 Tread portion
10a Cap tread portion
10b Undertread portion

1. A pneumatic tire comprising a cap tread portion, an undertread portion, and a belt cover layer from outside to inside in a tire radial direction; a rubber composition for an undertread forming the undertread portion comprising from 40 to 80 parts by mass of silica blended in 100 parts by mass of diene rubber containing 70 mass % or greater of natural rubber and/or isoprene rubber, and comprising a silane coupling agent blended by an amount from 2 to 15 mass % with respect to the silica; a ratio (S_{UT}/M_{UT}) of tensile strength at break (S_{UT}) to 300% deformation tensile stress (M_{UT}) being 1.80 or greater; and an absolute value |M_{UT}-M_{BC}| of difference between the 300% deformation tensile stress (M_{UT}) and 300% deformation tensile stress (M_{BC}) of a rubber composition for a belt cover forming the belt cover layer being 3.0 MPa or less.

2. The pneumatic tire according to claim 1, wherein the rubber composition for an undertread further comprises carbon black, and a mass ratio of the silica to total mass of the silica and carbon black is 0.4 or greater.

3. A method for manufacturing a rubber composition for a tire forming the undertread portion of the pneumatic tire according to claim 1, the method comprising: feeding silica and a silane coupling agent into a mixer together, mixing, and then feeding diene rubber, followed by kneading, in a case of manufacturing a rubber composition comprising 40 parts by mass or more and less than 80 parts by mass of the silica blended in 100 parts by mass of the diene rubber containing 50 mass % or greater of natural rubber and/or isoprene rubber, and comprising the silane coupling agent blended by an amount from 2 to 15 mass % with respect to the silica amount.

4. The method for manufacturing a rubber composition for a tire according to claim 3, wherein, together with the silica and the silane coupling agent, carbon black and/or aroma oil are fed and mixed.

5. A method for manufacturing a rubber composition for a tire forming the undertread portion of the pneumatic tire according to claim 2, the method comprising: feeding silica and a silane coupling agent into a mixer together, mixing, and then feeding diene rubber, followed by kneading, in a case of manufacturing a rubber composition comprising 40 parts by mass or more and less than 80 parts by mass of the silica blended in 100 parts by mass of the diene rubber containing 50 mass % or greater of natural rubber and/or isoprene rubber, and comprising the silane coupling agent blended by an amount from 2 to 15 mass % with respect to the silica amount.

6. The method for manufacturing a rubber composition for a tire according to claim 5, wherein, together with the silica and the silane coupling agent, carbon black and/or aroma oil are fed and mixed.
